(19) United States
(12) Patent Application Publication
(10) Pub. No.: US 2005/0114176 A1
(43) Pub. Date: May 26, 2005

(54) Method and system for automated debriefing of service activity

(76) Inventors: Mark B. Dominick, Waukesha, WI (US); Lawrence E. Ploetz, Brookfield, WI (US); James F. Kohli, Waukesha, WI (US)

Correspondence Address: Patrick S. Yoder;FLETCHER YODER, P.O. Box 692289, Houston, TX, 77269-2289, US

(21) Appl. No.: 10/722,657

(22) Filed: Nov. 26, 2003

(51) Int. Cl. G06F 17/60

(52) U.S. Cl. 705/2

(57) ABSTRACT

A system and method for facilitating the production of a service report of a service performed on a medical device by a service provider is provided. The service report contains medical device data related to the service performed on the medical device. The system may comprise a computing system operable to store and process data from a medical device. The system may also comprise a medical device operable to automatically transmit medical device data to the computer system. The system may also comprise a remote device operable to automatically transmit service provider data to the computer system. The method comprises operating the computer system to receive medical device data transmitted automatically by the medical system to the computer system. The method also comprises operating the computer system to receive service provider data transmitted automatically by a remote device to the computer system via the communications network. In addition, the method comprises operating the computer system to generate the service report based on the medical device data and the service provider data received from the medical device and the remote device.

### BACKGROUND OF THE INVENTION

The present invention relates generally to field of equipment services and documentation of records associated with the equipment servicing. More particularly, the invention relates to techniques for facilitating the servicing of medical systems and the documentation of information related to the servicing of the medical systems.

There are many different electronic devices available for learning about and treating patient conditions in the medical field. Over recent decades, more sophisticated systems have been developed that include various types of electrical data acquisition which detect and record the operation of systems of the body and, to some extent, the response of such systems to situations and stimuli. Even more sophisticated systems have been developed that provide images of the body, including internal features which could only be viewed and analyzed through surgical intervention before their development, and which permit viewing and analysis of other features and functions which could not have been seen in any other manner. All of these techniques have added to the vast array of resources available to physicians, and have greatly improved the quality of medical care.

However, many medical systems, such as medical imaging systems, are complex machines. As a result, they may require periodic servicing from a service provider. Typically, a service report, or some other documentation, is made to establish a record of the services that were performed on the medical system. A service report may contain many types of information related to the service. Typically, a service provider inputs this information into the service report manually. However, this may be time-consuming or lead to inconsistencies in the quality of reports from one service provider to another. Therefore, a need exists for a technique to reduce the time required to produce a service report and/or to improve the consistency in the quality of the service reports created.

### BRIEF DESCRIPTION OF THE INVENTION

A system and method for facilitating the production of a service report of a service performed on a medical device by a service provider is provided. The service report contains medical device data related to the service performed on the medical device. The system may comprise a computing system operable to store and process data from a medical device. The system may also comprise a medical device operable to automatically transmit medical device data to the computer system. The system may also comprise a remote device operable to automatically transmit service provider data to the computer system. The method comprises operating the computer system to receive medical device data transmitted automatically by the medical system to the computer system. The method also comprises operating the computer system to receive service provider data transmitted automatically by a remote device to the computer system via the communications network. In addition, the method comprises operating the computer system to generate the service report based on the medical device data and the service provider data received from the medical device and the remote device.

### BRIEF DESCRIPTION OF THE DRAWINGS

The foregoing and other advantages and features of the invention will become apparent upon reading the following detailed description and upon reference to the drawings in which:

FIG. 1 is a general diagrammatical representation of a medical information system, in accordance with an exemplary embodiment of the present invention;

FIG. 2 is block diagram of a process for facilitating the preparation of a service report for service performed on a medical device using data collected automatically from the medical device and a remote device, in accordance with an exemplary embodiment of the present invention; and

FIG. 3 is a representation of an electronic version of a service report generated in accordance with the process illustrated in FIG. 2, in accordance with an exemplary embodiment of the present invention.

### DETAILED DESCRIPTION OF SPECIFIC EMBODIMENTS

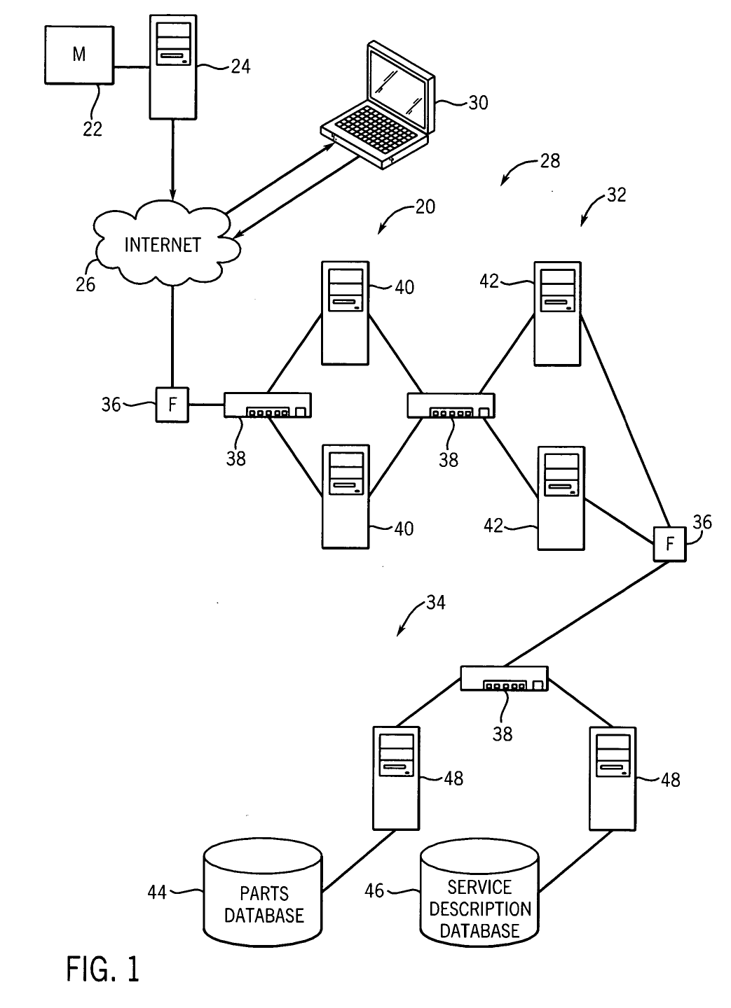

Referring generally to FIG. 1, a medical information system 20 is illustrated. In the illustrated embodiment, the medical information system 20 comprises a medical imaging system 22, such as a magnetic resonance (“MR”) imaging system, a computed tomography (“CT”) imaging system, or a positron emission tomography (“PET”) imaging system. However, the present techniques are applicable to other types of medical devices. The medical imaging system 22 is operable to produce an electronic image of a test subject. In addition, the medical imaging system 22 is connected by a computer 24 to a network 26, such as the Internet. Periodically, a service may need to be performed on the medical imaging system 22 by a service provider. For example, the services of a service provider may be retained to improve the images produced by the medical imaging system 22. Furthermore, a service provider may be retained to repair or replace a defective component of the medical imaging system 22. A service provider may also be used to upgrade old software or load new software into the medical imaging system 22.

The medical information system 20 also comprises a service center 28. The service center 28 enables a service provider to diagnose or repair problems associated with the medical imaging system 22. The service center 28 is coupled to the medical imaging system 22 via the network 26. The network 26 enables data to be transmitted from the medical imaging system 22 to the service center 28. For example, medical images taken by the medical imaging system 22 may be transmitted via the network to the service center 28 for analysis by a service provider. In addition, the medical imaging system 22 automatically transmits service data to the service center 28. In the illustrated embodiment, the medical imaging system 22 is self-aware, i.e., the medical imaging system 22 inventories its software and hardware and automatically transmits service data representative of the change made to the software or hardware to the service center 28 when a change is made to the software or hardware. In this regard, the medical imaging system 22 is similar to a personal computer that has plug-and-play capability.

In the illustrated embodiment, a remote device 30 is provided to enable a service provider to communicate with the medical imaging system 22 and the service center 28. The remote device 30 may be a desktop computer, a notebook computer, a personal digital assistant (“PDA”), or some other communications device. In addition, the remote device 30 provides service provider data automatically to the service center 28. For example, the remote device 30 may be used to initiate and track service time. In addition, in the illustrated embodiment, the remote device 30 provides Global Positioning System (“GPS”) data continuously to the on-line service system 28 to enable the service center 28 track and document the movements of the service provider.

The service center 28 is a processor-based system that is operable to store and to process the service data from the medical imaging system 22 and the service provider data from the remote device 30. In the illustrated embodiment, the service center 28 automatically receives the service data from the medical imaging system 22 and the service provider data from the remote device 30 and uses the data to generate a service report. The service center 28 also transmits the service report to the service provider via the network, or some other communication network.

In the illustrated embodiment, the service center 28 begins collecting data for a specific service activity when the service center 28 receives a request for service. The collection of data related to the specific service activity ends when the service provider indicates to the on-line center 28 that the service has been performed. The service report comprises information describing the service performed and the service provider performing the service. For example, the service information may include the serial number of the medical imaging system and the service performed on the medical imaging system. The service provider data may include the time that it took the service provider to perform the service, billing information for the service provider, various expenses related to the service, and other pertinent pieces of data, such as the location of the service provider when the service was performed.

In the illustrated embodiment, the service center 28 comprises an application server system 32 and a data base server system 34 that contains various types of medical imaging system data for a plurality of different modalities of medical imaging systems. The application server system 32 is operable to process data from the medical imaging system 22, the remote device 30, and the data base server system 34. The application server system 32 comprises firewalls 36 and hubs 38. In addition, the application server system 32 comprises a plurality of load balancers 40 and web servers 42. The load balancers 40 balance the data loads to and from the web servers 42. The web servers 42 store and execute the software applications that enable the application server system 32 to process the data.

The database server system 34 comprises a parts database 44 and a service description database 46. The parts database 44 is coupled by a server 48 to a hub 38. In addition, the service description database 46 is coupled by a server 50 to the hub 38. The hub 38, in turn, is coupled to the application server system 32.

The parts database 44 maintains a history of parts used in the medical imaging system 22. As noted above, the medical imaging system 22 inventories its software and hardware. When a change is made to the inventory of the medical imaging system 22, the service data reflecting the change in the inventory is provided automatically from the medical imaging system 22 and coupled through the application server system 32 to the database server system 34. The database server system 34 updates the parts database 44 to reflect the change in the inventory. In addition, the parts database 44 is updated whenever a part is ordered, shipped, tracked, and delivered. Data from the parts database 44 is used to generate the service report. The collection of the data for use in generating the service report begins when the service center 28 receives a request for service and ends when the service provider indicates to the on-line center 28 that the service has been performed.

The service description database 46 maintains a history of the services performed on the medical imaging system 22. In addition, the service description database 46 contains service provider data provided by the remote device 30. However, service data may be provided to the service description database 46 from devices other than the remote device 30. Data from the parts database 44 is used to generate the service report. The collection of the data for use in generating the service report begins when the service center 28 receives a request for service and ends when the service provider indicates to the on-line center 28 that the service has been performed.

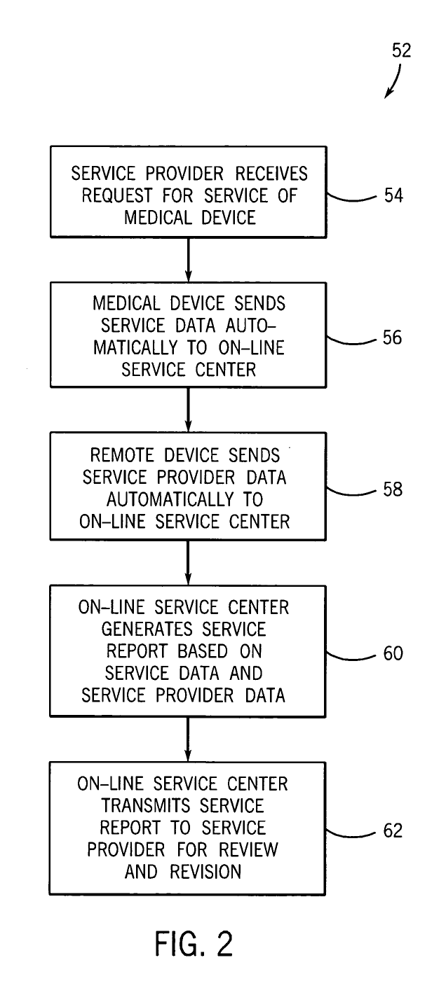

Referring generally to FIG. 2, a method of servicing the medical imaging system 22 and documenting the service is illustrated. The method is represented generally by reference numeral 52. In the illustrated embodiment, the method begins with a service provider, such as a field engineer or an on-line engineer, receiving a request for service on the medical imaging system 22, represented generally by block 54. The service provider then begins performing the service on the medical imaging system 22.

The receipt of the request for service begins the collecting of data for use in generating the service report. The medical imaging system 22 automatically sends service data to the service center 28 for storage in the parts database 44, represented generally by block 58. As noted above, the service data includes any change in the inventory of the medical imaging system 22 hardware or software. In addition, the remote device automatically provides service provider data to the service center for storage in the service description database 46, represented generally by block 60. The service provider data may be the start time for performing the service, the end time for performing the service, the location of the service provider, and other service related data.

On direction of the service provider, the service center 28 creates a service report based on the service data received from the medical imaging system 22 and the service provider data received from the remote device 30, as represented generally by block 62. The service report is stored electronically in the service center for transmittal to a customer or service provider. In the illustrated embodiment, the service center 28 sends a copy of the service report to the service provider for review, as represented by block 64. The service center 28 also enables the service provider to revise/edit the service report.

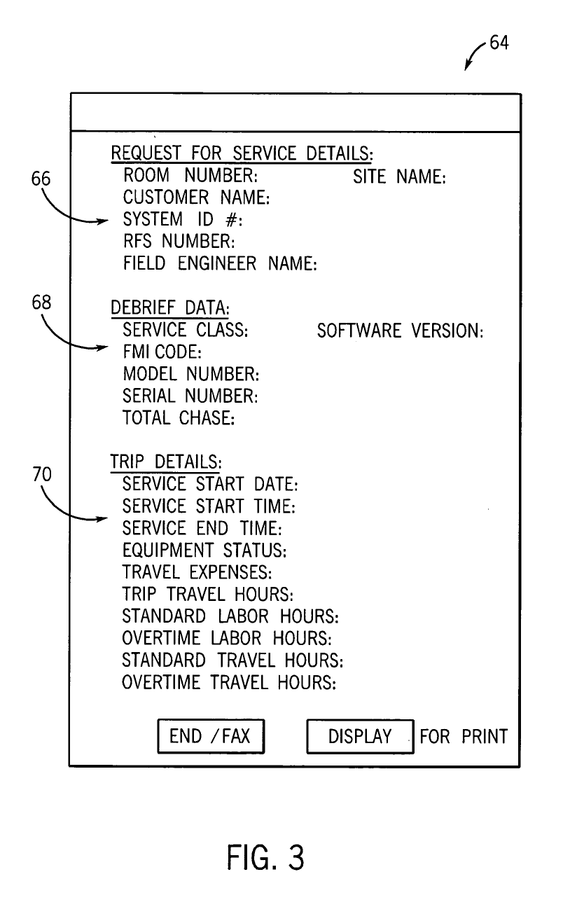

Referring generally to FIG. 3, an embodiment of a service report 64 generated by the service center 28 is illustrated. As noted above, the service report 64 may be transmitted to the remote device 30 via the network 26. The service report 64 may be e-mailed or accessed by the service provider over the network 26. The service provider may review and revise the service report with a computer, a digital assistant, or some other form of communication device. In addition, the service report may be edited.

The service report 64 provides the service provider with data received with the request for service and the service data and service provider data received automatically from the medical imaging system 22 and the remote device 30, respectively, and stored in the database server system 24. The illustrated service report 64 has a first portion 66 that contains information related to the request for service provided to initiate the service activity to be performed. In the illustrated embodiment, the first portion 66 discloses the room number of the medical device to be serviced, the customer name, the identification number of the medical imaging system, the request for service number, and the field engineer/service provider's name. The illustrated service report 64 also discloses the site name of the medical imaging system 22. The site name is established by comparing the GPS data provided by the remote device 30 with location data stored in the database server system 24.

The service report 64 has a second portion 68 that contains information related to the service performed on the medical imaging system 22. For example, in the illustrated embodiment, the second portion 68 comprises the class of the service performed, the field modification instruction code, the model number of the medical imaging system 22, the serial number of a part replaced during the service, the version of software upgraded or downloaded, and the total charge for the service performed on the medical imaging system.

The illustrated service report 68 also has a third portion 70 that contains trip information for the service provider. For example, in the illustrated embodiment, the third portion 70 contains the service start date, the service start time, the service end time, the equipment status upon completion of the service, travel expenses associated with the service, trip travel hours, standard labor hours, and overtime labor hours. The remote device 30 is used to mark the various time intervals. This information is used to establish the charge for the service. The illustrated service report 64 also has a virtual button 72 that sends a copy of the service report 64 to the online service center, or another location, when activated. The service report 64 also has a virtual button 74 that displays the service report in a print-friendly form.

By automatically storing and processing service data from the medical imaging system 22 and service provider data from the remote device 30, the system and method described above reduces the time required to produce a service report. In addition, by automatically inputting the data into the service report, the service report will be more consistent and the quality of the service report will improve.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A method for producing a service report for a service performed on a medical device by a service provider, comprising:
operating a computer system to receive medical device data transmitted automatically to the computer system via a communications network;
operating the computer system to receive service provider data transmitted automatically to the computer system via the communications network, and
operating the computer system to generate the service report based on the medical device data and the service provider data.

2. The method as recited in claim 1, wherein the service provider data comprises GPS location data from a remote device transported by the service provider.

3. The method as recited in claim 1, wherein the service provider data comprises timekeeping data for the service provider.

4. The method as recited in claim 1, wherein the medical device is operable to detect an alteration of at least one of medical device hardware and medical device software and the medical device data transmitted automatically by the medical device is representative of the alteration to the medical device.

5. The method as recited in claim 1, comprising operating the computer system to transmit the service report to a remote device for review by a service provider.

6. A method for facilitating the preparation of a service report for a medical device; comprising:
providing service data automatically from the medical device to a computer system via a communications network;
providing service provider data automatically to the computer system via a communications network; and
generating a service report based on the service data and the service provider data automatically using the computer system.

7. The method as recited in claim 6, wherein the service report comprises a listing of services performed by the service provider based on the service provider data.

8. The method as recited in claim 6, wherein the service report comprises a listing of parts replaced by the service provider based on the service data.

9. The method as recited in claim 6, wherein the service provider data comprises GPS location data for the service provider and the service report comprises the GPS location data.

10. The method as recited in claim 6, wherein the service report comprises service time data for the service provider.

11. The method as recited in claim 6, comprising transmitting the service report from the computer system to a remote device to enable a user to revise the service report.

12. A medical information system, comprising:
a medical device comprising hardware and software, the medical device being operable to communicate with a remote computer via a communication system, wherein the medical device is operable to detect a change in each of the hardware and the software and to automatically transmit a signal representative of the change to the remote computer.

13. The medical information system as recited in claim 12, wherein the medical device is a medical imaging system.

14. The medical information system as recited in claims 12, wherein the communication system comprises the network.

15. A computer program, comprising:
programming instructions stored in a tangible medium, wherein the programming instructions enable a processor-based device to produce a service report for a medical device based on medical device data received automatically from the medical device and service provider data received automatically from a remote device.

16. The program as recited in claim 15, wherein the programming instructions enable the processor-based device to produce a service report containing data representative of at least one of a hardware and a software change to the medical device.

17. The program as recited in claim 15, wherein the programming instructions enable the processor-based device to produce a service report containing GPS data for the remote device.

18. The program as recited in claim 1, wherein the remote device is operable to track time used by a service provider to perform a service on the medical device and the service data comprises an indication of the time used by a service provider to perform a service on the medical device and the service data.

19. The system as recited in claim 2, wherein the system enables a user to use the remote device to revise the service report and to transmit the revised service report to the computer system via the network.
